(19) United States
(12) Patent Application Publication
(10) Pub. No.: US 2024/0376947 A1
(43) Pub. Date: Nov. 14, 2024

(54) ACTUATOR ASSEMBLY OF AN ELECTROMECHANICAL VEHICLE BRAKE, AND METHOD FOR MOUNTING AND DISMOUNTING A BRAKE PISTON IN AND FROM AN ACTUATOR ASSEMBLY

(71) Applicant: ZF Active Safety GmbH, Koblenz (DE)

(72) Inventors: Marco Becker, Oberduerenbach (DE); Florian Roessinger, Neuwied (DE); Michael Weins, Muenstermaifeld (DE); Lukas Madzgalla, Lahnstein (DE); Hans Friedrich, Koblenz (DE)

(21) Appl. No.: 18/660,310

(22) Filed: May 10, 2024

(30) Foreign Application Priority Data
May 10, 2023 (DE) 102023112349.1

(51) Int. Cl. F16D 65/18; F16D 65/097; F16D 121/24; F16D 125/40

(52) U.S. Cl. CPC F16D 65/18; F16D 65/0979; F16D 2121/24; F16D 2125/40; F16D 2250/0084

(57) ABSTRACT

An actuator assembly of an electromechanical vehicle brake has a linearly displaceable brake piston, a brake calliper unit having a holder for the brake piston, and a rotation prevention arrangement. The rotation prevention arrangement comprises a ring pushed onto a contact surface on the brake piston and connected in a rotationally fixed manner to the brake piston at an inner circumferential surface. The ring has at least one radially outwardly protruding securing projection, and a groove associated with the securing projection, which runs in the axial direction in the inner circumferential surface of the holder. A method for mounting and dismounting the brake piston is also disclosed.

### CROSS-REFERENCE TO RELATED APPLICATION

This application claims priority to German Priority Application No. 102023112349.1, filed May 10, 2023, the disclosure of which is incorporated herein by reference in its entirety.

### TECHNICAL FIELD

The disclosure relates to an actuator assembly of an electromechanical vehicle brake and to a method for mounting and dismounting a brake piston in and from an actuator assembly.

### BACKGROUND

Actuator assemblies for vehicle brakes usually have a linearly displaceable brake piston which is guided in a brake calliper unit and which serves to apply a brake pad to a brake rotor, also called a brake disc. For this purpose, the brake piston is moved by a spindle drive, for example. In order to convert a rotation of the spindle completely into a linear movement of the brake piston, the brake piston must be guided in a rotationally secure manner in the brake calliper unit.

What is needed is to implement a rotation prevention arrangement for a brake piston in an electromechanical vehicle brake in as simple a manner as possible and with a small installation space requirement.

### SUMMARY

An actuator assembly of an electromechanical vehicle brake is disclosed, the electromechanical vehicle brake, having a brake piston which is linearly displaceable in an axial direction and which serves to apply a brake pad to a brake rotor, a brake calliper unit in which there is formed a holder having an inner circumferential surface which forms a running surface for the brake piston, and a rotation prevention arrangement. The rotation prevention arrangement comprises a ring pushed onto a contact surface on the brake piston and connected in a rotationally fixed manner to the brake piston at the inner circumferential surface, the ring having at least one radially outwardly protruding securing projection, and a groove which runs in the axial direction in the inner circumferential surface of the holder. The securing projection is held in such a manner that the brake piston is guided in a rotationally secure manner in the brake calliper unit.

The arrangement of the ring on the contact surface on the brake piston saves axial installation space, since a component fixed to the housing of the actuator assembly is not necessary for the rotation prevention arrangement.

In one exemplary arrangement, the ring has a plurality of securing projections, for example two or three securing projections, distributed along the circumference, wherein for each of the securing projections there is an associated groove in the holder.

The ring is generally circumferentially closed. For example, it can be produced as a one-piece stamped part from a metal sheet.

Normally, the inner circumferential surface of the ring and the securing projections lie in a common plane, and the ring has no axial projections or depressions.

In one exemplary arrangement, the groove is closed at an end directed towards the brake piston and forms an axial stop for the securing projection. An axial movement of the brake piston can thus be limited in a simple manner.

In one exemplary arrangement, the groove is also closed at the opposite end, so that the length of the groove defines a length of the displacement movement of the brake piston.

The groove in the brake calliper unit can be manufactured with high precision, so that the displacement path of the brake piston can be specified with great accuracy.

Simple mounting of the ring on the brake piston can be achieved if the ring is pressed onto the brake piston. In one exemplary arrangement, the ring is fixed on the contact surface by force-based engagement solely by the frictional and clamping forces that are generated by pressing.

The contact surface on the brake piston is a circumferential surface at an axial end of the brake piston that is directed into an interior of the holder. The contact surface thus points towards a drive of the actuator assembly, which provides the displacement movement of the brake piston. The drive is a spindle drive, for example.

The contact surface is slightly conical with a diameter which widens away from an axial end of the contact surface at the axial end of the brake piston. In section perpendicular to the axial direction, the contact surface is circular, so that the angular position of the brake piston and of the ring relative to one another during mounting of the ring on the brake piston is arbitrary.

The contact surface terminates at its end opposite the axial end of the brake piston and in one exemplary arrangement, at an axial shoulder. In principle, the shoulder forms an end stop for the ring in the state in which it is mounted on the brake piston. In the mounted state, the ring optionally abuts the shoulder, for example with a lateral surface which radially adjoins the inner circumferential surface.

The brake piston can have an engagement structure for a tool which serves to remove the brake piston from the holder.

The engagement structure is, for example, a circumferential radial groove at the axial end of the brake piston opposite the contact surface, that is to say at the end of the brake piston that is on the brake shoe side, and is displaceable out of the holder. The tool is used only to extract the brake piston from the brake calliper unit when the brake piston is to be removed from the electromechanical brake for replacement or for the maintenance of components.

A method for mounting a brake piston in an actuator assembly as has been described above, the method comprises the following steps:
introducing the ring into the holder so that the securing projection engages into the groove, and
then pushing the brake piston into the holder, wherein a sufficiently high axial force is applied in the axial direction in the direction towards the holder that the ring is pressed at its inner circumferential surface onto the contact surface on the brake piston.

Pressing of the ring onto the contact surface ends at the latest when the ring, as described above, abuts the shoulder at the axial end of the contact surface. Optionally, this is the specified mounting position.

In order to also be able to insert the securing projection of the ring into a groove in the holder that is closed on both sides, the ring may be tilted relative to the axial direction in order to insert the securing projection into the respective groove. When the securing projection is located in the respective groove, the ring is again oriented with its ring plane perpendicular to the axial direction before the brake piston is pushed on.

In an alternative exemplary arrangement, the groove is opened at an axial end in the manner of a bayonet fitting and the ring is rotated in the circumferential direction in order to insert the securing projection into the groove.

In order to dismount the brake piston from an above-described actuator assembly again, the following steps are carried out:
a tool is attached to an engagement structure of the brake piston, and
an axial extraction force is applied to the brake piston by the tool, wherein a sufficiently high axial force is applied in the axial direction in the direction away from the holder that the ring is detached at its inner circumferential surface from the contact surface on the brake piston.

Due to the axial force, the ring is separated from the brake piston again, so that the brake piston can first be withdrawn from the holder, wherein the ring becomes caught at the stop surfaces at the closed end of the groove. After the brake piston has been removed, the ring can be tilted axially and then removed from the holder.

The actuator assembly can thus be dismounted with little effort. For example, the brake piston can be replaced or supplied separately to recycling or reconditioning. If a new brake piston is to be mounted, it is mounted in the holder again, optionally with a new ring, as described above.

Mounting and/or dismounting of the ring can optionally be assisted by the application of a temperature difference.

### BRIEF DESCRIPTION OF THE DRAWINGS

The disclosure will be described in greater detail hereinbelow in connection with an exemplary arrangement with reference to the accompanying figures, in which:

FIG. 1 shows a schematic exploded representation of an actuator assembly according to the disclosure for carrying out the method according to the disclosure; and

FIG. 2 shows a schematic perspective view in partial section of the actuator assembly from FIG. 1.

### DETAILED DESCRIPTION

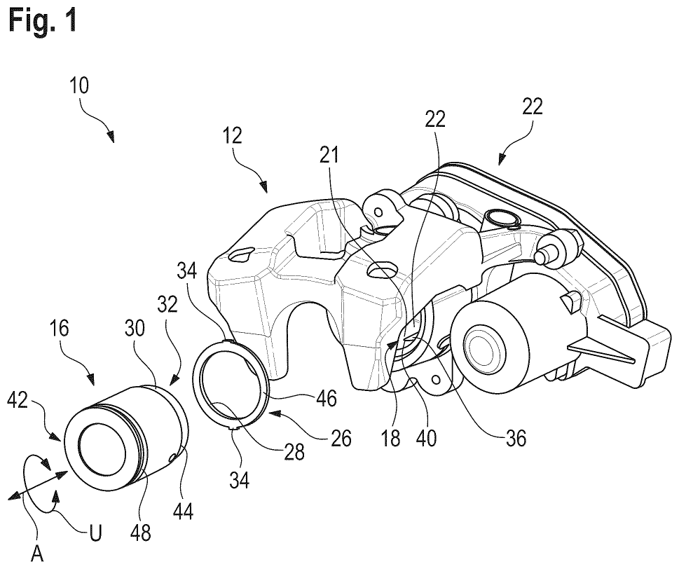

FIG. 1 shows an actuator assembly 10 of an electromechanical vehicle brake (not shown in detail). The actuator assembly 10 comprises a brake calliper unit 12 having an intermediate space 14 in which there are arranged a brake rotor and, on each side thereof, a brake shoe (not shown). The brake shoes are pressed against the brake rotor by the linear movement of a brake piston 16.

The brake piston 16 is held in a cylindrical holder 18 in the brake calliper unit 12 in such a manner that it is linearly displaceable in an axial direction A, which corresponds to a longitudinal direction of the brake piston 16.

A drive unit 20 comprises a drive for moving the brake piston 16 in the axial direction A, for example a spindle drive.

An inner circumferential surface 21 of the holder 18 is matched in an accurately fitting manner to an outer surface of the brake piston 16 and forms a running surface 22 for the brake piston 16.

The brake piston 16 is secured against rotation about the axial direction A by a rotation prevention arrangement 24.

The rotation prevention arrangement 24 comprises a ring 26 which is pressed with an inner circumferential surface 28 onto a circumferential contact surface 30 at a first axial end 32 of the brake piston 16.

The ring 26 rests on the contact surface 30 in such a manner that the frictional forces between the inner circumferential surface 28 of the ring 26 and the contact surface 30 are sufficiently great that, in normal operation of the actuator assembly 10, the ring 26 is connected in a rotationally fixed manner to the brake piston 16.

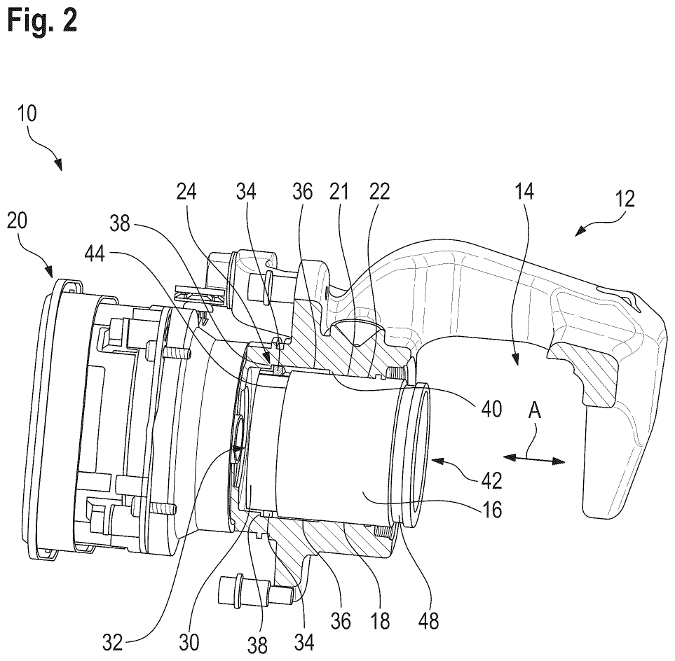

The ring 26 has one or more radially protruding securing projections 34. There are two diametrically opposite securing projections 34 here. The inner circumferential surface 21 of the holder 18 has an axially extending groove 36 for each securing projection 34, into which groove the respective securing projection 34 engages (see FIG. 2).

The groove 36 is only insignificantly wider than the securing projection 34 in the circumferential direction U about the axial direction A, so that the brake piston 16 is guided linearly without a large amount of play.

The ring 26 is in one piece in the exemplary arrangement and may be a stamped sheet-metal part. In this example, the ring 26 is flat and has the same thickness in the axial direction A over its entire surface.

Each of the grooves 36 has an axial stop 38, 40 at its axial ends. If the securing projection 34 reaches the respective axial stop 38, 40, a further axial movement of the brake piston 16 in the direction in question is prevented. The distance between the two axial stops 38, 40 therefore defines the range of movement of the brake piston 16 in the axial direction A.

In this example, the stop 38 is arranged at an axial end of the groove 36 that is directed towards the contact surface 30 and accordingly towards the first axial end 32 of the brake piston, and the stop 40 is arranged at an axial end of the groove 36 that is directed towards the intermediate space 14 and thus towards a second axial end 42 of the brake piston 16.

The securing projections 34 in the grooves 36 on the one hand prevent the brake piston 16 from rotating in the circumferential direction U about the axial direction A and on the other hand limit the displacement path of the brake piston 16 in the axial direction A on the path between the axial stops 38, 40.

The contact surface 30 in this example is circular in the circumferential direction U and is formed without radial depressions or projections. In the axial direction A, it terminates in a radial widened portion, which forms a shoulder 44 (see FIG. 1). The contact surface 30 is here circular cylindrical or slightly conical. In the second case, the diameter of the contact surface 30 increases slightly from the end 32 to the shoulder 44.

The contact surface 30 extends directly from the first axial end 32 of the brake piston 16 to the shoulder 44.

In order to mount the brake piston 16 in the holder 18, the ring 26 is first introduced into the holder 18, wherein it is tilted relative to the axial direction to such an extent that the securing projections 34 can be inserted into the associated grooves 36.

The ring 26 is then oriented perpendicular to the axial direction A and the brake piston 16 is pressed with the contact surface 30 onto the ring 26.

The ring 26 and the brake piston 16 are moved relative to one another in the axial direction A with a sufficiently high axial force until the ring 26 is connected in a rotationally fixed manner to the brake piston 16. The axial force is chosen to be sufficiently high that the ring 26 always remains connected in a rotationally fixed manner to the brake piston 16 in normal operation of the electromechanical brake and of the actuator assembly 10.

During pressing, the ring 26 optionally moves axially along the contact surface 30 until its lateral surface 46 abuts the shoulder 44. The shoulder 44 may constitute an end stop for the displacement movement of the ring 26 during mounting.

If the brake piston 16 is to be removed from the actuator assembly 10 again, for example because a component is to be maintained or replaced, a tool (not shown) is attached to an engagement structure 48 in the region of the second axial end 42 of the brake piston 16 and an extraction force is applied in the axial direction A away from the holder 18. This force is to be chosen to be sufficiently great that the force-based engagement between the inner circumferential surface 28 of the ring 26 and the contact surface 30 is overcome and the ring 26 moves relative to the contact surface 30 and is thus detached from the brake piston 16.

In this example, the engagement structure 48 is a circumferential radial groove shortly before the second axial end 42 of the brake piston 16.

During the extraction movement, the ring 26 is retained in the holder 18 by the axial stop 40. Once the brake piston 16 has been separated from the ring 26, the ring 26 can be tilted relative to the axial direction A and likewise removed from the holder 18.

A new or maintained brake piston 16 can then be inserted into the holder 18 as described above.

Pressing and/or extraction of the ring 26 are optionally assisted by the action of heat.

1. An actuator assembly of an electromechanical vehicle brake, comprising a brake piston which is linearly displaceable in an axial direction and which serves to apply a brake pad to a brake rotor, a brake calliper unit in which there is formed a holder having an inner circumferential surface which forms a running surface for the brake piston, and a rotation prevention arrangement, wherein the rotation prevention arrangement comprises a ring pushed onto a contact surface on the brake piston and connected in a rotationally fixed manner to the brake piston at an inner circumferential surface, said ring having at least one radially outwardly protruding securing projection, and a groove, associated with the securing projection, the groove running an axial direction in the inner circumferential surface of the holder and in which the securing projection is held in such a manner that the brake piston is guided in a rotationally secure manner in the brake calliper unit.

2. The actuator assembly according to claim 1, wherein the groove is closed at an end directed towards the contact surface and forms an axial stop for the securing projection.

3. The actuator assembly according to claim 1, wherein the ring is pressed onto the brake piston.

4. The actuator assembly according to claim 1, wherein the contact surface on the brake piston is a circumferential surface at an axial end of the brake piston that is directed into an interior of the holder.

5. The actuator assembly according to claim 1, wherein the contact surface terminates at an axial shoulder which forms an axial end stop for the ring in a mounted state.

6. The actuator assembly according to claim 1, wherein the brake piston has an engagement structure for a tool which serves to remove the brake piston from the holder.

7. A method for mounting a brake piston in an actuator assembly according to claim 1, having the following steps:
introducing the ring into the holder so that the securing projection engages into the groove, and
then pushing the brake piston into the holder, wherein an axial force is applied in the axial direction in the direction towards the holder that the ring is pressed at its inner circumferential surface onto the contact surface on the brake piston.

8. The method according to claim 7, wherein the ring is tilted relative to the axial direction in order to insert the securing projection into the groove.

9. A method for dismounting a brake piston from an actuator assembly according to claim 1, having the following steps:
attaching a tool to an engagement structure of the brake piston, and applying an axial extraction force to the brake piston by applying the tool, wherein a sufficiently high axial force is applied in the axial direction in the direction away from the holder that the ring is detached at its inner circumferential surface from the contact surface on the brake piston.

10. The actuator assembly according to claim 2, wherein the ring is pressed onto the brake piston.

11. The actuator assembly according to claim 10, wherein the contact surface on the brake piston is a circumferential surface at an axial end of the brake piston that is directed into an interior of the holder.

12. The actuator assembly according to claim 11, wherein the contact surface terminates at an axial shoulder which forms an axial end stop for the ring in a mounted state.

13. The actuator assembly according to claim 12, wherein the brake piston has an engagement structure for a tool which serves to remove the brake piston from the holder.
